(19) United States
(12) Patent Application Publication
(10) Pub. No.: US 2025/0314797 A1
(43) Pub. Date: Oct. 9, 2025

(54) MONITORING THE STATE OF A VIBRONIC SENSOR

(71) Applicant: Endress+Hauser SE+Co. KG, Maulburg (DE)

(72) Inventors: Benjamin Monse, Vogtsburg (DE); Tobias Müller, Fischingen (DE); Kaj Uppenkamp, Wehr (DE); Armin Wernet, Rheinfelden (DE); Ralf Leisinger, Wieslet (DE)

(21) Appl. No.: 18/863,410

(22) PCT Filed: May 10, 2023
(86) PCT No.: PCT/EP2023/062448

§ 371 Date: Nov. 6, 2024

(30) Foreign Application Priority Data
May 11, 2022 (DE) 10 2022 111 828.2

(51) Int. Cl. G01V 3/02

(52) U.S. Cl. CPC G01V 3/02

(57) ABSTRACT

A computer-implemented method for operating a device for determining and/or monitoring a process variable of a medium, wherein the device comprises a sensor unit and electronics having at least one component with a binary input and/or output, wherein at least a first and a second value for an input and/or output signal of the component correspond to a first and/or second state of the component, comprises: detecting a first and/or second value for the input and/or output signal corresponding to the first and/or second state, comparing the first and/or second value with a first and/or second predefinable reference value for the first and/or second state, and on the basis of the comparison, detecting the presence of an electrically conductive substance in the region of the component.

The invention relates to a method, in particular a computer-implemented method for operating a device for determining and/or monitoring at least one process variable of a medium, a computer program for carrying out the method according to the invention, and a computer program product on which a computer program according to the invention is stored. The medium is preferably located in a container, for example in a tank or in a pipe.

Field devices are used for monitoring and/or determining at least one, for example chemical or physical, process variable of a medium. Within the framework of the present application, all measuring devices that are used in proximity with the process and that supply or process process-relevant information are, in principle, termed field devices, including therefore remote I/O's, wireless adapters and general electronic components located on the field level. The companies of the Endress+Hauser Group produce and distribute a large variety of such field devices.

For example, the field device can be a fill level measuring device, flow measuring device, pressure and temperature measuring device, pH and/or pH redox potential measuring device, as well as a conductivity measuring device which serves to detect the corresponding process variables in each case such as a fill level, a flow rate, the pressure, the temperature, a pH value, a redox potential, or a conductivity. The respectively underlying measuring principles are sufficiently known from the prior art and are not listed individually at this point. Flow-measuring devices are, in particular, Coriolis, ultrasound, vortex, thermal and/or magnetically inductive flow-measuring devices. Fill level measuring devices in turn are, in particular, microwave fill level measuring devices, ultrasonic fill level measuring devices, time domain reflectometry fill level measuring devices (TDR), radiometric fill level measuring devices, capacitive fill level measuring devices, conductive fill level measuring devices, and/or vibronic fill level measuring devices. By contrast, pressure measuring devices are preferably what are known as absolute, relative, or differential pressure devices, whereas a temperature measuring device can have, for example, a thermal element or temperature-dependent resistor for determining the temperature.

A field device comprises at least one sensor unit that at least partially and at least temporarily comes into contact with the process, as well as electronics which, for example, serves to detect, evaluate, and/or supply signals. The electronics can either be attached directly to the sensor unit, or they are placed at a spatial distance from the field device and can be connected to the field device. For numerous applications, in particular safety-critical applications, it is necessary that the particular field device operates as reliably as possible and can be exposed to a wide variety of environmental conditions such as major temperature and/or moisture fluctuations.

In order to ensure high reliability in such environmental conditions, the electronics are therefore often potted to prevent, for example, the ingress of moisture. On the other hand, with fully potted electronics, the question of ease of use sometimes arises.

Accordingly, the object of the present invention is to provide a possibility with which a field device can operate reliably under a wide variety of environmental conditions and at the same time ensure easy operation.

This object is achieved by a method, in particular a computer-implemented method, for operating a device for determining and/or monitoring at least one process variable of a medium, wherein the device comprises a sensor unit and electronics, wherein the electronics have at least one component with a binary input and/or output, and wherein an input and/or output signal of the component has/have a first or second state corresponding to a first or second predefinable reference value for the input or output signal of the component. The method includes the following method steps:
detecting a first and/or second value for the input and/or output signal corresponding to the first and/or second state,
comparing the first and/or second value with a first and/or second predefinable reference value for the first and/or second state, and
on the basis of the comparison, detecting the presence of an electrically conductive substance in the region of the component.

According to the invention, the input and/or output signal of the component is/are detected, and the particular values are compared with reference values for the first and/or second state. Based on the comparison, for example a deviation from the limit value beyond a predefinable threshold value, the presence of an electrically conductive substance in the region of the component can be inferred.

The method according to the invention serves to improve the functional safety and reliability of a field device in a simple manner. In particular, it can be achieved that a field device which is designed to carry out a method according to the invention achieves a higher level of safety or a higher level of availability. Structural measures on the particular field device are not necessary. Both a diagnosis can be prepared and predictive maintenance can be carried out.

For example, it is conceivable that the component of the electronics with the binary input and/or output is freely accessible, while several, in particular all, other components of the electronics are potted. In this case, it is advantageous that highly reliable electronics is possible with simultaneous easy and economically feasible operation of the electronics via the component with the binary input and/or output.

In one embodiment of the method, the first and/or second value for the input and/or output signal is/are recorded as a function of time. In this way, a temporal evaluation of the signal curve can be performed, and in particular a temporal correlation and also a pattern recognition can be carried out. This in turn allows for improved and expanded diagnosis.

In a further embodiment, the component is a switching element which can be switched between a first and a second switching state. For example, it is a push button switch, an opener, a closer or a changeover contact.

In this context, it is advantageous if the first and second values for the input and/or output signal of the switching element correspond to the first and second switching states of the switching element. By the comparison according to the invention of the values for the input and/or output signal with the particular predefinable reference values, it is then possible, for example, to detect an unwanted switching of the switching element.

In a further embodiment of the method, the component is a digital interface.

In this context, it is in turn advantageous if the first and second values of the input and/or output signals of the interface correspond to a first and second state of the interface.

Another embodiment of the method according to the invention includes that the electrically conductive substance is a conductive liquid, for example water, in particular penetrating moisture. The method can therefore be used to detect the presence of moisture or condensation in the region of the component.

It is advantageous if a message is issued about the presence of the electrically conductive substance in the region of the component. In this respect, both diagnosis and predictive maintenance are conceivable.

In a preferred embodiment of the method, it is determined whether a difference between the first and/or second value for the input and/or output signal exceeds or falls below a predefinable first threshold value. Above a specific deviation from the predefinable reference value, in principle from a target value for the input and/or output signal, reliable functionality of the component can no longer be ensured. Such a comparison can lead to a more reliable assessment than a direct comparison of individual values.

A further embodiment includes that a process, for the execution of which the component is used, is not executed as long as the electrically conductive substance is present in the region of the component, i.e., as long as the value for the input and/or output signal exceeds or falls below the predefinable limit value. A specific action or a specific process will therefore not be executed as long as the substance, for example moisture, is present in the region of the component, for example in the region of the switching element or the interface. In this way, the unwanted execution of a specific process due to the presence of the substance can be avoided. In this respect, a switching element can, for example, be a switching process, and an interface can be a signal transmission.

In particular, it is advantageous in this context if the process, for the execution of which the component is used, is executed when the difference between the first and/or second value for the input and/or output signal does not exceed or fall below the predefinable first limit value or a predefinable second limit value. As soon as the predefinable first limit value is exceeded or undershot, the process is no longer executed. Only when the first limit value or, for example in the case of hysteresis, a predefinable second limit value is no longer exceeded or undershot, the process is executed again.

The object forming the basis of the invention is further achieved by a computer program for determining at least one process variable of a medium with computer-readable program code elements that, when executed on a computer, cause the computer to execute a method according to the invention.

The object underlying the invention is likewise achieved by a computer program product having a computer program according to the invention and at least one computer-readable medium on which at least the computer program is stored.

The method can in particular be implemented on a microcontroller.

The method is preferably used for a device for determining and/or monitoring at least one process variable of a medium, wherein the device comprises a sensor unit and electronics, which electronics are at least partially potted, encapsulated, or surrounded by a housing, in particular tightly, and wherein at least one component with a binary input and/or output, for example a switching element or a digital interface, is not potted, encapsulated, or surrounded by a housing, in particular tightly. In this context, it is advantageously possible to increase the level of safety of the field device using the method according to the invention without having to implement structural measures for this purpose. This makes it possible to create a cost-effective field device with a high level of safety. The method is also used to detect an electrically conductive substance in the region of the component in the event that a housing of a corresponding device is not sealed, for example because a cover has been removed or the like. In this case, it is not important that the component in question is not potted, encapsulated or surrounded by a housing, in particular tightly.

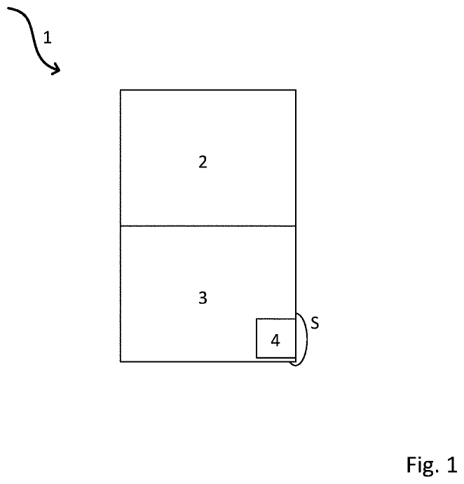

The invention and its advantages are described in more detail with reference to the following figures, FIG. 1 and FIG. 4. In the drawings:

FIG. 1 is a schematic diagram of a field device with a sensor unit and electronics with a component with a binary input and/or output;

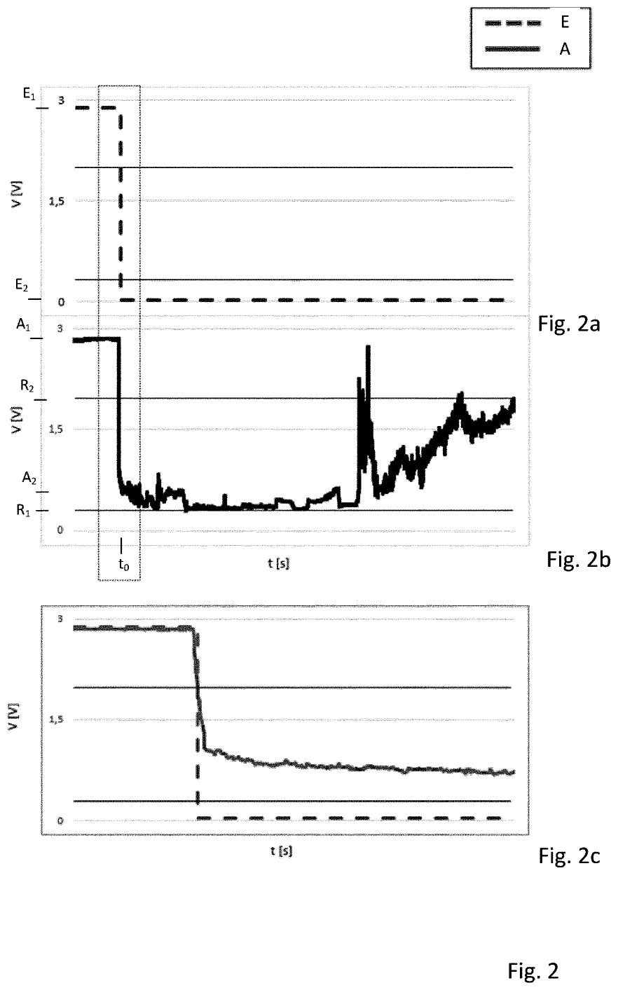

FIG. 2 is the time curve of the input and/or output signal as a function of time for a component in the form of a switching element;

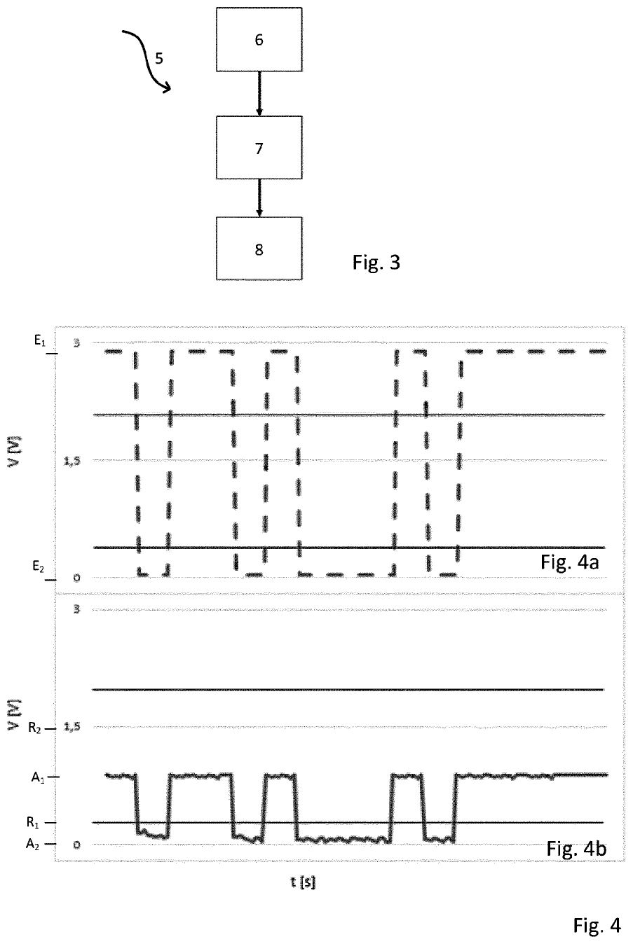

FIG. 3 is a schematic representation of a digital interface; and

FIG. 4 is the time curve of the input and/or output signal as a function of time for a component in the form of a digital interface.

FIG. 1 shows a field device 1 with a sensor unit 2 and electronics 3 which have a component 4 with a binary input and/or output.

With the method according to the invention it is possible to detect the presence of an electrically conductive substance S in the region of the component 4, for example condensation on the component 4. For example, it is conceivable that the component is a component of the electronics 3 accessible from the outside, while one or all other components of the electronics 3 can be potted, encapsulated, or surrounded by a housing.

The method according to the invention is based on a comparison of values for the input E and/or output signal A with reference values R corresponding to a first and second state Z. A first exemplary embodiment of the method according to the invention is illustrated below with reference to FIG. 2. In the case of FIG. 2, component 4 is a switching element which switches back and forth between a first switching state and a second switching state.

In FIG. 2a, the input signal E is shown as a function of time t. At the point in time t₀, a switching process is triggered. At this point in time to, the input signal E changes from a first value E₁ to a second value E₂. The output signal A is shown in FIG. 2b, also as a function of the time t. The output signal A also changes at the point in time to from a first A₁ to a second value A₂. The first value corresponds to a first switching state, and the second value corresponds to a second switching state. The recorded value A₂ for the output signal A corresponding to the second state of the switching element is, however, greater than a predefinable reference value R₁ for the value of the output signal A. From this deviation or from the comparison with the reference value R₁, the presence of a conductive substance S, in particular water, for example condensation, in the region of the switching element 4 can be inferred.

The signal curves of the input E and output signal A are shown again in FIG. 2c in an enlarged view at the point in time to.

In FIG. 2, an optional additionally usable reference value R₂ is also shown. As can be seen from FIG. 2b, the output signal A in the case of the presence of the conductive substance S in the second switching state (t>t₀) is not constant, but shows various jumps. An additional comparison with a second reference value R₂ therefore makes it possible to also take the hysteresis or the like into account when changing back to the first switching state and to also prevent unwanted switching in this respect.

FIG. 3 shows a schematic representation of a digital interface 5 with an external control element or a communication unit 6, an analog-digital converter 7 and a computing unit 8. Such an interface 5 can also be a component 4 with a digital input and/or output within the meaning of the present invention.

Similar to the case of FIG. 2, for a component 4 in the form of a digital interface 5 in FIG. 4, the input signal E and the output signal A are each shown as a function of time t. The input signal E changes periodically back and forth from a first state which corresponds to a first value E₁ for the input signal E, and a second state which corresponds to a second value E₂ for the input signal E (FIG. 4a). The situation is similar with the output signal A (FIG. 4b). However, in any case, the predefinable first reference value R₁ is not exceeded in each case, which is why it is inferred that no conductive substance S is present in the region of the interface 5.

### REFERENCE SIGNS

1 Field device
2 Sensor unit
3 Electronics
4 Component
5 Digital interface
6 External control element, communication unit
7 Analog-digital converter
8 Computing unit
E Input signal
A Output signal
R Reference value
S Substance

1-13. (canceled)

14. A method for operating a device for determining and/or monitoring at least one process variable of a medium, wherein the device includes a sensor unit and electronics having a component with a binary input and/or output, and wherein at least a first and a second value for an input and/or output signal of the component correspond to a first and/or second state of the component, the method comprising:
detecting a first and/or second value for the input and/or output signal corresponding to the first and/or second state;
comparing the first and/or second value with a first and/or a second predefinable reference value for the first and/or second state; and
on the basis of the comparison, detecting a presence of an electrically conductive substance in a region of the component.

15. The method according to claim 14, further comprising:
detecting the first and/or second value for the input and/or output signal as a function of time.

16. The method according to claim 14,
wherein the component is a switching element which can be switched between a first and a second switching state.

17. The method according to claim 16,
wherein the first and second values for the input and/or output signal of the component correspond to the first and second switching states of the switching element.

18. The method according to claim 14,
wherein the component is a digital interface.

19. The method according to claim 18,
wherein the first and second value for the input and/or output signal of the component correspond to first and second states of the digital interface.

20. The method according to claim 14,
wherein the electrically conductive substance is a conductive liquid.

21. The method according to claim 14, further comprising:
issuing a message about the presence of the electrically conductive substance in the region of the component.

22. The method according to claim 14, further comprising:
determining whether a difference between the first and/or second value for the input and/or output signal exceeds or falls below a predefinable first limit value.

23. The method according to claim 14,
wherein a process, for the execution of which the component is used, is not executed as long as the electrically conductive substance is present in the region of the component.

24. The method according to claim 23,
wherein the process, for the execution of which the component is used, is executed when the difference between the first and/or second value for the input and/or output signal exceeds or falls below the predefinable first limit value or a predefinable second limit value.

25. A computer program product, comprising:
a computer program for determining at least one process variable of a medium with computer-readable program code elements which, when executed on a computer, cause the computer to execute a method for operating a device for determining and/or monitoring the at least one process variable of the medium, wherein the device includes a sensor unit and electronics having a component with a binary input and/or output, and wherein at least a first and a second value for an input and/or output signal of the component correspond to a first and/or second state of the component, wherein the method comprises:
detecting a first and/or second value for the input and/or output signal corresponding to the first and/or second state;
comparing the first and/or second value with a first and/or a second predefinable reference value for the first and/or second state; and
on the basis of the comparison, detecting a presence of an electrically conductive substance in a region of the component; and
at least one computer-readable medium on which at least the computer program is stored.
